(19) United States
(12) Patent Application Publication
(10) Pub. No.: US 2004/0035094 A1
(43) Pub. Date: Feb. 26, 2004

(54) Diesel engine exhaust filter

(76) Inventor: Ray De Jersey, East Malvern (AU)

Correspondence Address: TOD R. NISSLE, P.C., P.O. Box 55630, Phoenix, AZ, 85078, US

(21) Appl. No.: 10/411,069

(22) Filed: Apr. 10, 2003

Related U.S. Application Data
(60) Provisional application No. 60/371,646, filed on Apr. 10, 2002.

(51) Int. Cl. B01D 46/00

(52) U.S. Cl. 55/478; 55/502; 55/498; 55/524

(57) ABSTRACT

A diesel engine exhaust filter utilizes a filter media and a seal. The seal is made from a high temperature stable polymer material to retain the filter media in the filter.

### FIELD OF INVENTION

The present invention relates to a diesel engine exhaust filter. More particularly, the present invention relates to a diesel engine exhaust filter to assist in the removal of harmful particulates from diesel exhaust fumes.

### BACKGROUND ART

Diesel engine exhaust fumes are well recognised as containing harmful particulates which are deleterious to persons forced to breath the air in the immediate environment in which the emissions are generated. Various means for reducing particulate emissions have been proposed including scrubbing devices, catalytic converters and/or filter systems.

U.S. Pat. No. 4,264,344 (Ludeke et al) describes a diesel engine exhaust particulate trap in the form of a dual-path exhaust particulate filter assembly in which the filter elements are arranged concentrically with a pleated paper or fibreglass primary element surrounding a tubular mesh-filled secondary element. The described invention provides for by-pass flow to the secondary filter element. Gaskets 85 seal the ends of the primary filter element 74 whereby an openable outlet end wall 44 is pivotably mounted to a cylindrical outer shell 40 by a hinge member 46 normally retained in closed position by a spring clasp 48. This trap assembly is an expensive and unnecessarily elaborate means for sealing in the filter element 86 in light of the current practice of using disposable filter units.

In U.S. Pat. No. 5,488,826 (Paas) there is described a heat isolated catalytic reactor 10 installed inside a water jacketed exhaust manifold. The invention includes a filter assembly 18 housed in cylinder 64 attached to a flame arrester assembly 20. When the filter element 60 becomes clogged, end cap assembly 66 can be easily unclamped, the clogged filter element 60 removed and discarded, and a new filter element inserted into the housing 64. As described above, this arrangement is unsuitable given the current practice of using modular filter cannister units with no moving or removable parts.

The above described prior art does not disclose a filter arrangement in which the filter element is permanently fixed or secured within a filter housing such that it is correctly installed to achieve optimum efficacy.

It is an object of the present invention to provide a filter arrangement which overcomes the aforementioned disadvantages or at least provides a useful alternative thereto.

### SUMMARY OF THE INVENTION

The present invention provides a diesel engine exhaust filter for filtering particulate material from a stream of gas, the filter adapted to be received in a cannister and comprising:

a housing comprising at least two open housing walls defining a cavity therebetween;

a filter media retained within the housing walls in the cavity and adapted to filter the particulate material from the gas stream;

at least one seal made from high temperature stable polymer material to retain the filter media in the cavity; and

registration means for facilitating the alignment of the filter in the cannister.

A diesel engine emits exhaust gases bearing particulate material comprising substantially unburned hydrocarbons. Without treatment of the raw exhaust gases, such particulate material would be belched into the immediate environment surrounding the diesel engine exhaust outlet. This would create various degrees of hazard, depending on the effectiveness of any ventilation in the immediate environment. In particular, in enclosed environments such as underground mining, the need for the elimination of a substantial proportion of such particulate material from the breathable air is essential to the health of mine workers and to providing a safe work place as required by work place legislation in most jurisdictions. Health concerns range in degree from mild respiratory complaints such as night coughing, through to asthma and, in extreme cases, lung cancer. Particulate material greater than 0.3 micrometers in diameter present the greatest health risks. Therefore, preferably, the filter of the present invention is adapted to reduce the incidence of particulate material greater than 0.3 micrometers from the exhaust released into the surrounding environment.

The stream of gas initially emitted from a diesel engine, the raw exhaust gases, also comprise incompletely oxidised pollutant gases. These gases and the particulate material may, in part, be reduced in concentration by the use of other means such as a water scrubber.

The exhaust gases emanating from a diesel engine quickly reach very high temperatures of the order of 1200° F. (650° C.). Water scrubbing of the gaseous emissions may reduce the temperature of the resultant gas to 172-175° F. (78-80° C.) by the time the gas stream reaches the filter. In the past, it was considered impractical to use anything other than a metal seal to retain the filter media within the filter housing as evidenced by the above described prior art. It was considered that the use of anything other than metal was prone to fatigue and failure over extended use and that metal was the only suitable material available, ceramics being too brittle and impractical for such industrial applications.

The open housing walls of the housing may include a wide range of configurations and shapes provided they are suitable to the purpose. For example, the housing walls may be both square, rectangular, oval or circular shaped in transverse section. Preferably they are circular in section. The housing walls may be of consistent diameter throughout their length or may be, for example, pyramidal or conical. The housing walls may be co-terminus or may be of different lengths. Preferably, they are of the same length. Preferably the housing walls are concentric, coterminal and cylindrical. The housing walls preferably define an inner space into which the gas stream flows and continues through the housing walls and the filter media. The housing walls are preferably sufficiently light gauge to permit substantially unimpeded access of the exhaust gases to the filter media whilst being of a configuration sufficient to withstand the mechanical and heat-related riggers to which it is likely to be subjected by exposure to the gaseous diesel emissions. Moreover, because water scrubbing may typically precede the filter in the exhaust stream line, it is preferable that the metal be resistant to chemical corrosion. A particularly preferred metal for use in making the open housing walls is stainless steel.

The housing walls may comprise metal wire lengths. The wire lengths may be parallel wire lengths longitudinally aligned or spirally aligned to provide the gaseous stream with unimpeded access to the filter media. The housing walls preferably, however, comprise an open wire grill, mesh or lattice.

The filter media preferably extends substantially the length of the open housing walls. The filter media preferably terminates at a pair of opposite ends and at least one end of the filter media is preferably embedded in the at least one seal. The at least one seal preferably comprises an end cap thereby forcing the inflowing gas stream to continue through the housing walls and filter media. The opposite end of the housing may include an open end to permit ingress of the gas stream. The opposite end seal may be made of metal or of polymeric material.

The filter media may be bonded to the annular end seals at one or both ends with a semi-rigid flame retardant adhesive. The filter media may comprise any suitable configuration adapted to fit in the cavity defined by the housing walls. The filter media preferably has a high surface to volume ratio. For example, the filter media may be made from fibres, pleated or otherwise configured to present a large available surface area to the stream of gas. Preferably the filter media is pleated and the pleats are longitudinally aligned. Still more preferably, the filter media is made from micro blown fibre. Still more preferably, the filter media is made from pleated micro blown, permanently charged, rectangular polypropylene fibre. Preferably the filter media is capable of electrostatically capturing particulate material grains as part of a combination of mechanical and electrostatic capture features. Most preferably, the filter material is electret. The filter media may include a durable round synthetic fibre which is bound to a synthetic substrate for durability. In terms of filter efficiency in the particle size range of 0.3 to 0.7 micrometres, it is preferable that the filter media be capable of filtering out 90 to 95% of particulate material in this range. In terms of overall reductions in the amount of particulate material borne by the gas stream, it is preferable that the filter be capable of reducing the level of diesel particulate in the gas stream by 80%. It is preferable that the filter media does not support the growth of mould, mildew, fungus or bacteria which can, in themselves, contribute to airborne respiratory diseases. It is preferable that the filter media is resistant to high temperatures and humidity and is virtually unaffected by water. This is important because the gas stream from the water scrubber predictably includes water in the form of super heated steam.

The at least one seal is of a configuration and shape adapted to effect a seal of the cavity defined by the housing walls and of the inner space also defined by the housing walls. The seal may be made from any polymer material suitable to the purpose. The polymer material may include additives, such as carbon, glass, metal or ceramic fibres or particles. Preferably, the polymer material includes a fire retardant additive. The fire retardant additive may include a non-halogen containing fire retardant additive whereby to minimise ignitability and reduce emissions of combustion products sourced from the seal material. The polymer material may comprise polyurethane. The polymer material may include a medium density polyether elastomer. Preferably, the polymeric material includes a polyether comprising a mixture of polyoxyethylene and polyoxypropylene diols and triols with diphenyl methane diisocyanate quasi prepolymers.

The filter media may be housed in the housing by merely trapping the filter media in the cavity. An alternative is to secure the respective ends of the filter media to the inner surfaces of the respective seals at either end. Preferably, however, the filter media terminates at a pair of opposite ends and one end of the filter media is embedded in one of the seals. Accordingly, in production, the filter may be made by first fashioning the housing, inserting the filter material in the cavity, then moulding the seal ensuring that the filter media ends are firmly embedded therein whilst the polymeric material of the seals is in the molten state.

The seal may be moulded to include a handle for easy manipulation at one or both ends. Preferably, the handle is made from a strong polymeric material, optionally internally reinforced by metal wire or cable, or the handle may be made from steel, preferably stainless steel. The outer surface of the seal may include a recess around its periphery to locate an end cap having a complementary protrusion. Preferably, the recess is an annular groove and the end cap is round. Preferably the complementary protrusion is an annular flange, lip or bead.

The filter may include an ignition interrupter to prevent the diesel engine from starting unless the filter is correctly aligned in the cannister. The ignition interrupter includes any suitable arrangement to detect the presence or absence of a correctly fitted and aligned filter. The ignition interrupter may complete the ignition circuit only in the presence of a correctly aligned filter. The ignition interrupter may include a pressure sensor in or on the cannister. The ignition interrupter may include an induction coil or circuit. The ignition interrupter may be located on the cannister. The filter may include complementary ignition interrupter means to interact with the ignition interrupter. The complementary interrupter means may be shaped or configured to register with a complementary and corresponding feature. The corresponding feature may be a particularly shaped recess and the complementary interrupter means may be a correspondingly shaped protrusion. For example, the corresponding feature may be a triangular, square, circular, oval or polygonal recess and the complimentary interrupter means may be correspondingly triangular, square, circular, oval or polygonal, respectively.

The ignition interrupter may include one or more complementary features which must all be successfully activated to ensure completion of the engine ignition circuit. For example, on the downward face of an end of the filter, the ignition interrupter may comprise a plurality of equidistant and symmetrically arranged complementary features.

The registration means may include means for longitudinally aligning the filter relative to the cannister. The registration means may include physical registration features on the outer surface of the housing or the upper or lower ends of the filter and complementary registration features on the inside wall of the cannister. For example, the outer side surface of the seal may include one or more longitudinally aligned recesses for receiving one or more correspondingly aligned protrusions on the internal wall surface of the cannister. Poor alignment or registration of the filter in the cannister can result in contaminated raw exhaust by-passing the filter and being delivered, unfiltered, to the immediate environment thereby causing a health hazard.

These and other features and advantages of the invention will be more fully understood from the following description of a preferred embodiment, taken together with the accompanying drawings.

### BRIEF DESCRIPTION OF THE DRAWINGS

In the drawings,

FIG. 1 is a schematic side section view of a portion of the diesel engine exhaust filter according to a preferred embodiment of the invention,

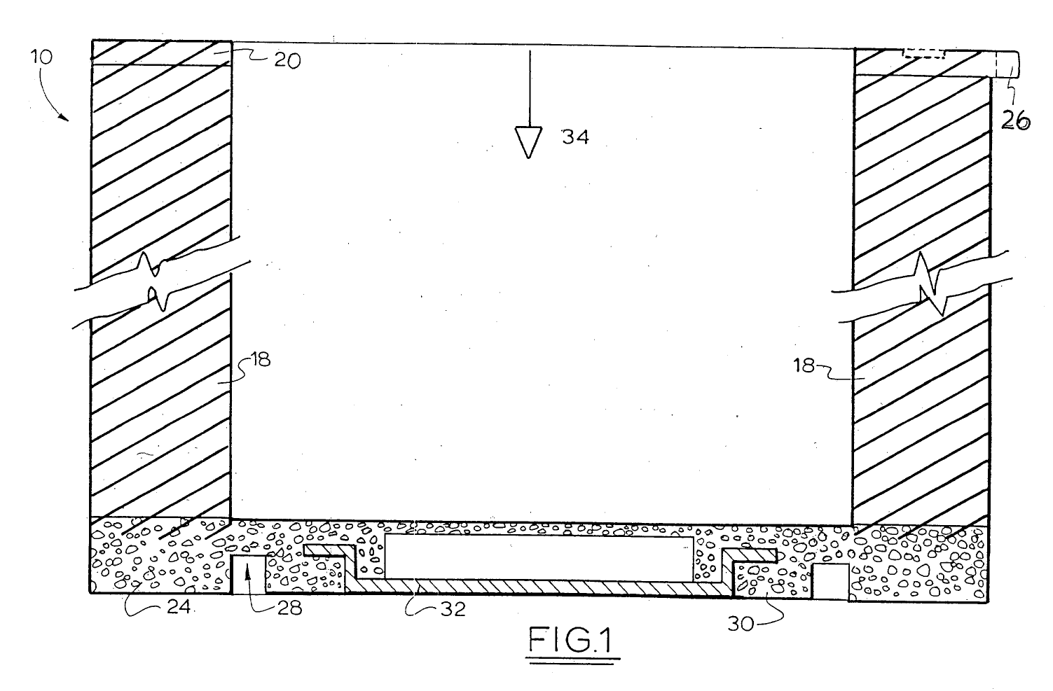

FIG. 2 is a perspective view of the filter shown in FIG. 1,

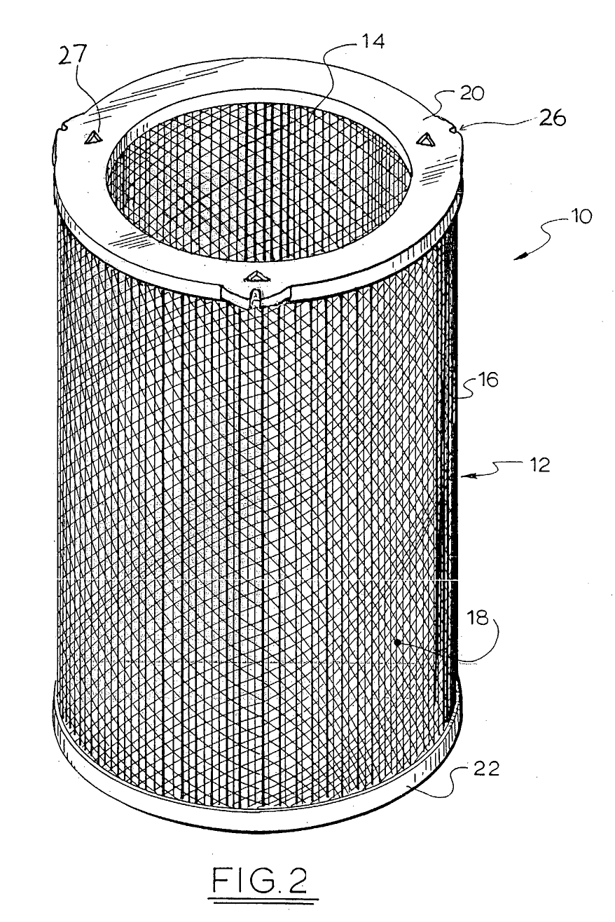

FIG. 3 is a perspective view of a cannister according to one embodiment, and

FIG. 4 is a schematic diagram showing an exhaust system incorporating the filter according to the preferred embodiment.

Referring to the drawings, there is shown a diesel engine exhaust filter 10 including a housing 12. The housing 12 includes a pair of concentric, co-terminal open mesh cylinders comprising inner cylinder 14 and outer cylinder 15 which define an annular cavity therebetween. Interposed between the cylinders 14, 16 in the cavity is a longitudinally pleated filter media 18 which is embedded at each of its ends in the polymeric material from which the top and bottom end seals 20, 22 are formed.

The seal material may be made from high temperature resistant polyurethane. The seal material may include a polyether comprising a mixture of polyoxyethylene and polyoxypropylene diols and triols with diphenyl methane diisocyanate quasi prepolymers. In manufacture, the filter is assembled by interposing the filter media 18 in the cavity defined by the inner and outer cylinders 14, 16, extending each end of the cylinders into a dye and moulding a seal in place at each end of the cylinders. The ends of the cylinders and the filter media are embedded in outer annular ring body 24 of the lowermost seal 22. The uppermost annular seal may alternatively be a conventional metal end seal 20 to which the filter media 18 may be bonded by a semi-rigid flame retardant adhesive. The end seal 20 includes on its outer side surface three equispaced recesses 26 set in profiled portions extending outwards beyond the profile of the end seal 20 rim. Adjacent each recess 26 on the upper facing surface of seal 20 is a triangular shaped recess 27 adapted to coact with complementary features in a cannister 40 adapted to house the filter 10.

The lowermost end seal 22 made of polymeric material completely seals off the lower end of the housing 12. The lower seal 22 includes a groove radially adjacent and inside the annular ring 24. The groove 28 is adapted to locate a cover (not shown) which may be fitted to the lower seal 22. Radially inside the annular groove and sharing the inner wall of the annular groove 28 is a pair of handle locaters 30 integrally moulded with the lower seal 22. Extending into and between the handle mountings 30 is a handle 32 rotatable in apertures formed in the lower seal 22 mould to receive the respective ends of the handle 32.

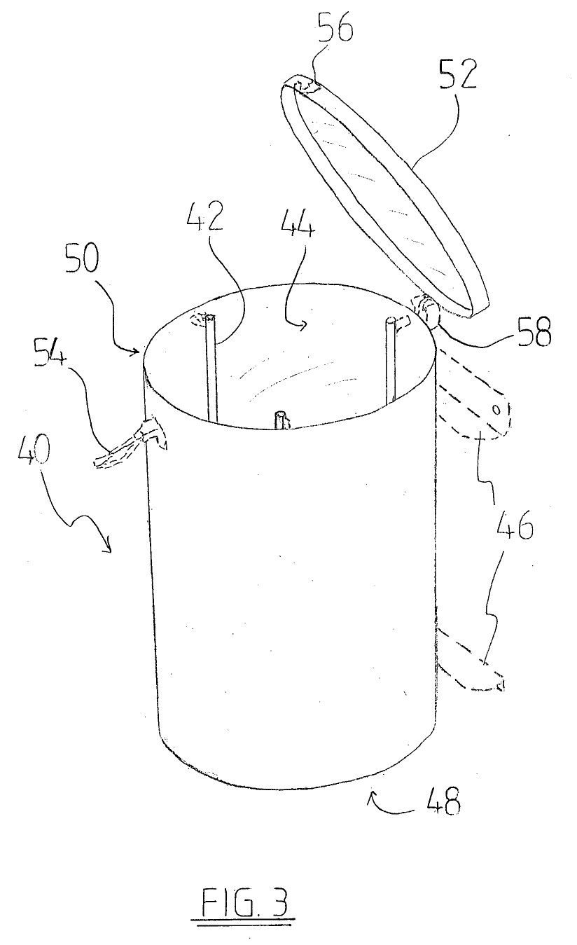

Registration means in the form of three longitudinally aligned, equispaced rods 42 are welded to the internal wall 44 of the cannister 40 substantially along its full length as shown in FIG. 3. The cannister 40 comprises a hollow cylinder manufactured from 3 mm thick stainless steel. The rods 42 enable the filter 10 to be aligned and supported in the cannister 40 and further facilitates filter replacement by making filter registration in the cannister 40. The cannister 40 optionally includes mounting brackets 46 for securing to an engine frame (not shown). The cannister 40 includes a lower end 48 and an upper end 50. The upper end 50 includes a compound hinged cover 52 which is machined from 12 mm thick stainless steel with a machined section to accommodate a dye cut seal made from material suitable for severe service. The inner seal is mechanically fastened to the cannister 40. The cover 52 is secured by one over centre clip 54 releasably engagable to a hook 56 to facilitate quick no-fuss filter replacement. The over centre clip 54 is located diametrically opposite a hinge 58. Optionally, the cannister 40 may include two or more over centre clips 54 to ensure a secure fit and seal of the cover 52 on the cannister 40. The cannister 40 is provided with inlet and exhaust fittings to suit each individual application and vary in their dimensions, configurations and placement. The seals, gaskets and over centre clips may be available as spare parts enabling their easy replacement should a failure occur. In another embodiment, the cannister may accommodate a double filter element to suit higher engine outputs or individual requirements.

In use, the filter 10 is manipulated by the handle 32 by an operator into the open cannister 40 by aligning the grooves 26 with the rods 42 to ensure correct registration. The filter 10 is inserted fully into the cannister 40 until the triangular recesses 27 receive the complementary triangular protrusions (not shown) in the base 48 of the cannister 40. The insertion of each complementary triangular protrusion into its corresponding triangular recess 27 completes part of the ignition circuit thereby enabling the operator to start the diesel engine. If the complementary triangular protrusions are not correctly inserted in the corresponding triangular recesses 27, the ignition circuit will not be completed and the engine will not be able to be started.

Gas stream 34 enters the filter 10 from a water scrubber 78 interposed between a diesel engine 76 and the filter 10 and is forced by pressure through the filter media 18 housed in the cavity of the housing 12. Particulate material greater than 0.3 micrometres in size is substantially captured by the filter media 18 by mechanical and electrostatic means thereby resulting in an exhaust gas stream including substantially less particulate matter than initial gas stream 34.

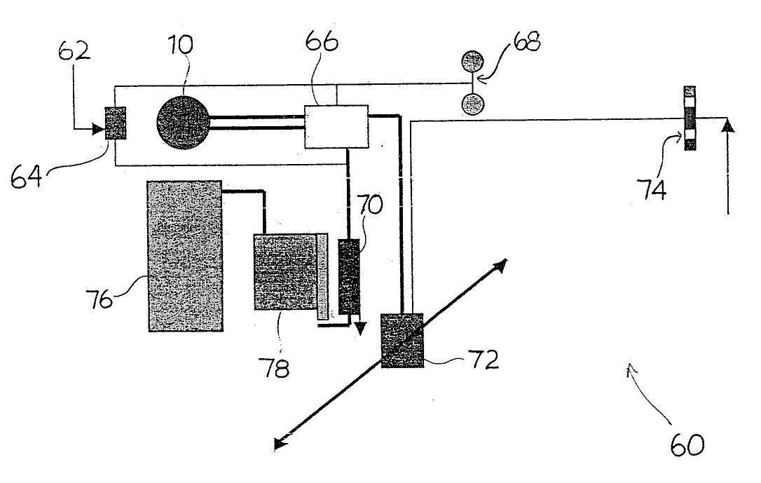

In the system 60 shown in FIG. 4, the system includes an air supply 62 fed into a control sensor 64. The system 60 includes the filter 10, a waste gate 66 in communication with a by-pass indicator 68. Connected to the waste gate 66 is an exhaust water separator 70 and exhaust directional control 72 in communication with a direction indicator/control 74. Typically, the system includes an engine 76 and water scrubber or conditioner 78.

The waste gate 66 provides a filter by-pass mechanism in which the filter 10 will be by-passed at a predetermined exhaust back pressure. The setting is usually the maximum back pressure as recommended by the engine manufacturer. A visual warner is displayed by the by-pass indicator 68 on the operator's control panel when the filter 10 is in by-pass mode.

The exhaust directional control 72 allows the operator to select from which end of the vehicle or machine that the exhaust will discharge thereby allowing the discharge to always be “downwind” of the operator. A pneumatic toggle valve set up on the operator's panel selects the direction. Visual indication of the exhaust direction is shown on the panel.

The exhaust water separator 70 fits between the conditioner exhaust discharge 78 and the filter input pipe via the waste gate 66. The exhaust water separator 70 removes about 65% of water and some of the heavier particles that would normally enter the filter 10 whereby to improve the life of the filter 10. Optionally, an engine back pressure warning device may be fitted which gives a visual and audible warning to the operator should the maximum back pressure of the exhaust be exceeded and may be included in addition to the waste gate 66. The engine back pressure warning device may be attempted to automatically test and clean itself on engine start up.

In conjunction with the exhaust waste gate 66, an exhaust scavenger pump may be included to ensure that the exhaust discharge is always kept at atmospheric pressure to allow the filter 10 to work up to its design capacity, thereby extending the filters 10 life.

Whilst this invention has been described with reference to a single preferred embodiment, it will be understood by skilled artisan that a wide variety of changes could be made to the various features described in detail without departing from the spirit and scope of the invention embodied therein. It will be understood by the skilled person that the invention is not intended to be limited by the disclosed embodiment, but that the invention be accorded the full scope permitted by the language of the following claims.

I claim:

1. A diesel engine exhaust filter for filtering particulate material from a stream of gas, the filter comprising:
a housing comprising at least two coaxial open housing walls defining at least one cavity therebetween;
a filter media retained within the housing walls in the cavity and adapted to filter the particulate material from the gas stream;
at least one end seal made from high temperature stable polymer material to retain the filter media in the cavity; and
registration means to facilitate alignment of the filter in the cannister.

2. The filter claimed in claim 1 wherein the housing walls are co-terminal.

3. The filter claimed in claim 1 wherein the housing walls are cylindrically shaped.

4. The filter claimed in claim 1 wherein the filter media terminates at a pair of opposite ends and at least one end of the filter media is embedded in the at least one seal.

5. The filer claimed in claim 1 wherein the seal is made from a material including medium density polyether elastomer.

6. The filter claimed in claim 1 wherein the seal is made from a material including polyurethane.

7. The filter claimed in claim 1 wherein the seal is made from a material including a fire retardant additive.

8. The filter claimed in claim 1 wherein the seal is made from a material including non-halogen containing fire retardant additive.

9. The filter claimed in claim 1 wherein the seal is made from a material including a polyether comprising a mixture of polyoxyethylene and polyoxypropylene diols and triols with diphenyl methane diisocyanate quasi prepolymers.

10. The filter claimed in claim 1 wherein the filter media is adapted to filter from the stream of gas particulate material greater than 0.3 micrometres.

11. The filter claimed in claim 1 wherein the filter media is pleated and the pleats are longitudinally aligned.

12. The filter claimed in claim 1 wherein the filter media is made from microblown fibre.

13. The filter claimed in claim 1 wherein the filter media is made from pleated microblown permanently charged rectangular polypropylene fibre.

14. The filter claimed in claim 1 wherein the housing walls are made of metal material.

15. The filter claimed in claim 1 wherein the housing walls are made from stainless steel.

16. The filter claimed in claim 1 wherein the registration means includes one or more grooves longitudinally aligned on the external side surface of the filter.

17. The filter claimed in claim 1 wherein the ignition interrupter includes one or more recesses located on the end surface of the seal adapted to cooperate with one or more corresponding by shaped protrusions in the cannister.

18. A cannister for housing the filter claimed in claim 1.

19. The cannister claimed in claim 18 wherein the registration means includes one or more rods or tracks located in the cannister for facilitating the correct alignment of the filter in the cannister.

20. The filter claimed in claim 1, further including an ignition interrupter to prevent the diesel engine from starting unless the filter is correctly aligned in the cannister.
